(19) United States
(12) Patent Application Publication
(10) Pub. No.: US 2008/0150894 A1
(43) Pub. Date: Jun. 26, 2008

(54) FOUR-DIRECTION SWITCH DEVICE

(75) Inventor: Hsiao-Lung Chiang, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/671,214

(22) Filed: Feb. 5, 2007

(30) Foreign Application Priority Data
Dec. 20, 2006 (TW) 095147861

(51) Int. Cl. G06F 3/033

(52) U.S. Cl. 345/163

(57) ABSTRACT

A four-direction switch device is used for facilitating the user to operate an electronic apparatus in four directions. The four-direction switch device includes a three-direction switch element, a swing module and a unidirectional switch element. The three-direction switch element is triggered to generate a first direction switching signal, a second direction switching signal and a third direction switching signal. The swing module includes a swing shaft such that the swing module is swung with respect to the swing shaft. The unidirectional switch element is triggered to generate a fourth direction switching signal when the swing module is swung to touch the unidirectional switch element.

### FIELD OF THE INVENTION

The present invention relates to a four-direction switch device, and more particularly to a four-direction switch device for use in an electronic apparatus.

### BACKGROUND OF THE INVENTION

In modern society, mobile electronic apparatuses such as mobile phones or personal digital assists (PDAs), MP3 players and mouse devices become essential because they are portable and convenient. Generally, these electronic apparatuses have respective user operation interfaces for facilitating users to operate these electronic apparatuses. In addition, the user operation interfaces include several tactile switches, which are actuated to execute specified functions. Take a conventional mouse device for example. Referring to FIG. 1, a schematic outward view of a mouse device having tactile switches is illustrated. The mouse device of FIG. 1 includes a first tactile switch 100 and a second tactile switch 102 on a sidewall thereof. In order to meet the users' requirements, the functions of the first tactile switch 100 and the second tactile switch 102 may be defined by the user under the user operation interface provided by the application program. Moreover, the functions of the first tactile switch 100 and the second tactile switch 102 are varied under execution of different application programs. For example, in a case that the computer system is operated with a Microsoft IE (Internet Explorer) browser program, the operation system executes a “previous page” command in response to activation of the first tactile switch 100, and executes a “next page” command in response to activation of the second tactile switch 102. Alternatively, when a text editing application program is executed, the first tactile switch 100 is actuated to copy the marked keywords, and the second tactile switch 102 is actuated to paste the selected keywords into designated position of the document.

Nowadays, with increasing demand of using the mouse device as the control device of a computer system, the mouse device is designed to execute a variety of functions. Since the layout area of the mouse device is limited, the conventional mouse device usually has at most two tactile switches. If the number of the tactile switches is increased, the operating interface for controlling the mouse device would be quite large. This operating interface becomes hindrance from using the mouse device because it has complicated design and is not user-friendly enough.

In views of the above-described disadvantages resulted from the prior art, the applicant keeps on carving unflaggingly to develop a four-direction switch device according to the present invention through wholehearted experience and research.

### SUMMARY OF THE INVENTION

It is an object of the present invention to provide a four-direction switch device for use in an electronic apparatus for facilitating the user to operate the electronic apparatus in four directions.

Another object of the present invention is to provide a four-direction switch device with reduced layout space.

A further object of the present invention is to provide a four-direction switch device, in which the functions of the four-direction switch device operated in four different directions may be defined by the user as required.

In accordance with an aspect of the present invention, there is provides a four-direction switch device. The four-direction switch device includes a three-direction switch element, a swing module and a unidirectional switch element. The three-direction switch element is triggered to generate a first direction switching signal, a second direction switching signal and a third direction switching signal. The swing module is coupled with the three-direction switch element and includes a swing shaft such that the swing module is swung with respect to the swing shaft. The unidirectional switch element is disposed beside the swing module. The swing module is swung toward the unidirectional switch element and touches the unidirectional switch element, so that the unidirectional switch element generates a fourth direction switching signal.

In an embodiment, the three-direction switch element includes a joystick part, which is operated in a first direction, a second direction, a third direction and a fourth direction to generate the first direction switching signal, the second direction switching signal, the third direction switching signal and the fourth direction switching signal, respectively.

In an embodiment, the swing module further includes a first substrate for mounting the three-direction switch element thereon, a recess structure for receiving the first substrate therein, and a pressing plate for touching the unidirectional switch element.

In accordance with an aspect of the present invention, there is provides a mouse device. The mouse device includes a housing and a four-direction switch device. The housing includes a base part and a sidewall. The four-direction switch device includes a three-direction switch element, a swing module and a unidirectional switch element. The three-direction switch element is triggered for generating a first direction switching signal, a second direction switching signal and a third direction switching signal. The three-direction switch element further includes a joystick part protruded from the sidewall part of the housing. The swing module is coupled with the three-direction switch element and includes a swing shaft such that the swing module is swung with respect to the swing shaft when the joystick part is operated by a user. The unidirectional switch element is disposed beside the swing module. The swing module is swung toward the unidirectional switch element and touches the unidirectional switch element, so that the unidirectional switch element generates a fourth direction switching signal.

In an embodiment, the mouse device further includes two supporting elements on the base part of the housing such that both ends of the swing shaft of the swing module are supported by the supporting elements.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic outward view of a conventional mouse device having tactile switches;

FIG. 2 is a schematic outward view of a mouse device having a four-direction switch device according to a preferred embodiment of the present invention;

FIG. 3 is a schematic exploded view of the four-direction switch device of FIG. 2; and

FIG. 4 is a schematic exploded view of a four-direction switch device according to another embodiment of the present invention.

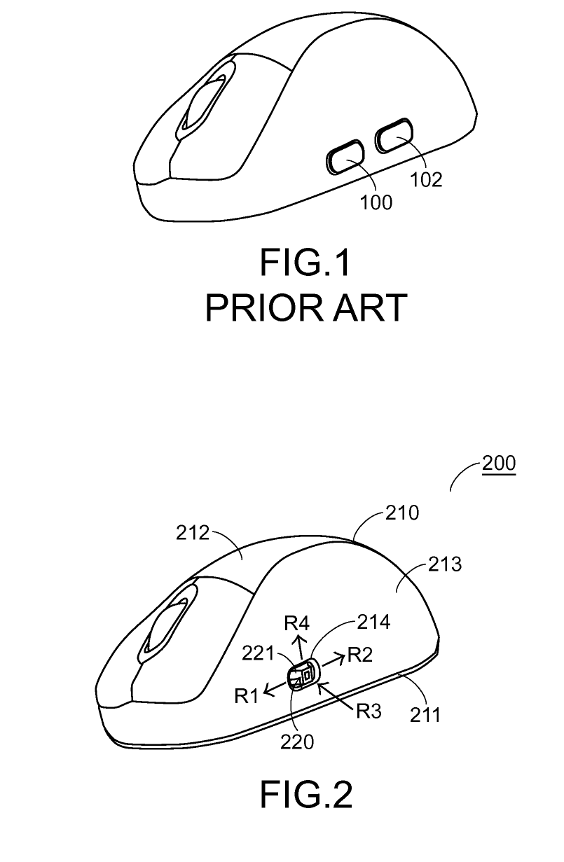

### DETAILED DESCRIPTION OF THE PREFERRED EMBODIMENT

Referring to FIG. 2, a schematic outward view of a mouse device having a four-direction switch device according to a preferred embodiment of the present invention is illustrated. The mouse device 200 of FIG. 2 includes a housing 210 and a four-direction switch device 220. The housing 210 includes a base part 211, an upper cover 212 and a sidewall part 213. The four-direction switch device 220 is positioned within the housing 210 of the mouse device 200. In addition, a joystick part 221 of the four-direction switch device 220 is protruded from an opening 214 at the sidewall part 213 of the housing 210, so that the joystick part 221 of the four-direction switch device 220 can be manipulated by a user. During operation of the mouse device 200, the joystick part 221 of the four-direction switch device 220 may be tilted toward four directions. For example, the joystick part 221 of the four-direction switch device 220 may be tilted in a left direction as shown in the arrow R1 to generate a first direction switching signal. Otherwise, the joystick part 221 of the four-direction switch device 220 may be tilted in a right direction as shown in the arrow R2 to generate a second direction switching signal. Furthermore, when the joystick part 221 of the four-direction switch device 220 is pressed down toward the housing 210 as shown in the arrow R3, a third direction switching signal is generated. When the joystick part 221 of the four-direction switch device 220 is tilted upwardly toward the upper cover 212 of the housing 210 as shown in the arrow R4, a fourth direction switching signal is generated.

In accordance with the features of the present invention, the joystick part 221 of the four-direction switch device 220 is operated in four directions to execute four different functions. For example, in a case that the computer system is operated with a Microsoft IE (Internet Explorer) browser program, the operation system executes a “previous page” command in response to the first direction switching signal, and executes a “next page” command in response to the second direction switching signal. Moreover, when a text editing application program is executed, the marked keywords is copied in response to the third direction switching signal, and the selected keywords is pasted into designated position of the document in response to the fourth direction switching signal.

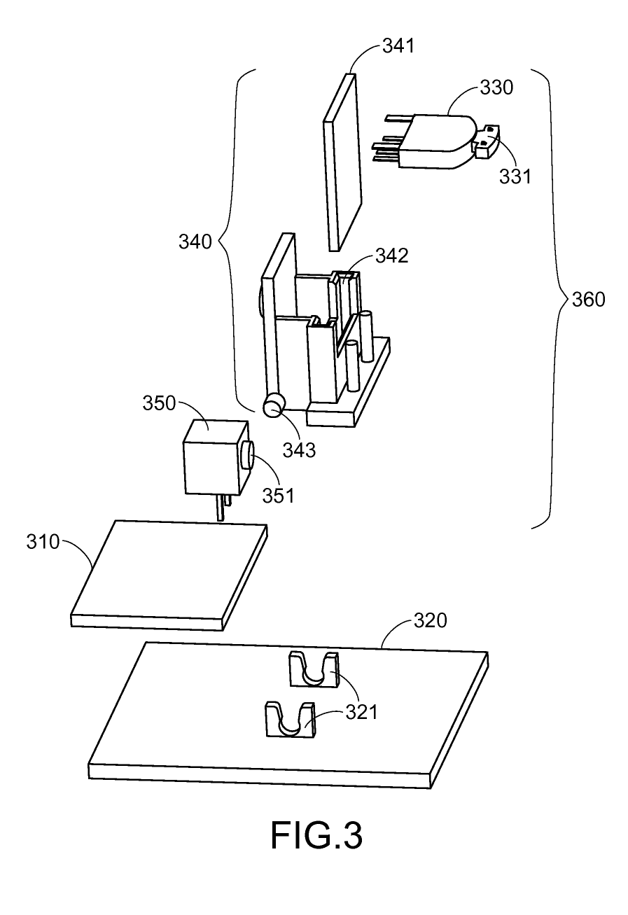

Referring to FIG. 3, a schematic exploded view of the four-direction switch device of FIG. 2 is illustrated. The four-direction switch device 360 is mounted on a mother substrate 310 such as a circuit board. The four-direction switch device 360 includes a three-direction switch element 330, a swing module 340 and a unidirectional switch element 350. The three-direction switch element 330 includes a joystick part 331. The swing module 340 includes a daughter substrate 341, a recess structure 342 and a swing shaft 343. The unidirectional switch element 350 has a push button 351 at a side thereof. The daughter substrate 341 is a daughter circuit board. For fixing the four-direction switch device 360 on the base part 320 of the mouse device 200, two supporting elements 321 are provided on the base part 320 such that both ends of the swing shaft 343 are supported by the supporting elements 321.

In addition, the three-direction switch element 330 is mounted on a surface of the daughter substrate 341, which is positioned in the recess structure 342 of the swing module 340. The unidirectional switch element 350 is mounted on the mother substrate 310 and disposed beside the swing module 340. After the both ends of the swing shaft 343 are supported by the supporting elements 321 of the base part 320, the four-direction switch device 360 is positioned within the mouse device 200 and the swing module 340 is swung with respect to the swing shaft 343.

When the joystick part 331 is operated in the first direction, the second direction and the third direction, the three-direction switch element 330 may generate the first direction switching signal, the second direction switching signal and the third direction switching signal, respectively. These three switching signals are transmitted to the mother substrate 310 through the daughter substrate 341.

When the joystick part 331 is operated in the fourth direction, the swing module 340 is swung toward the unidirectional switch element 350 with the swing shaft 343 serving as a rotating shaft. Once the swing module 340 touches the push button 351 of the unidirectional switch element 350, the fourth direction switching signal is generated and transmitted to the mother substrate 310. Due to the restoring force of the push button 351, the swing module 340 will be then returned to its original position.

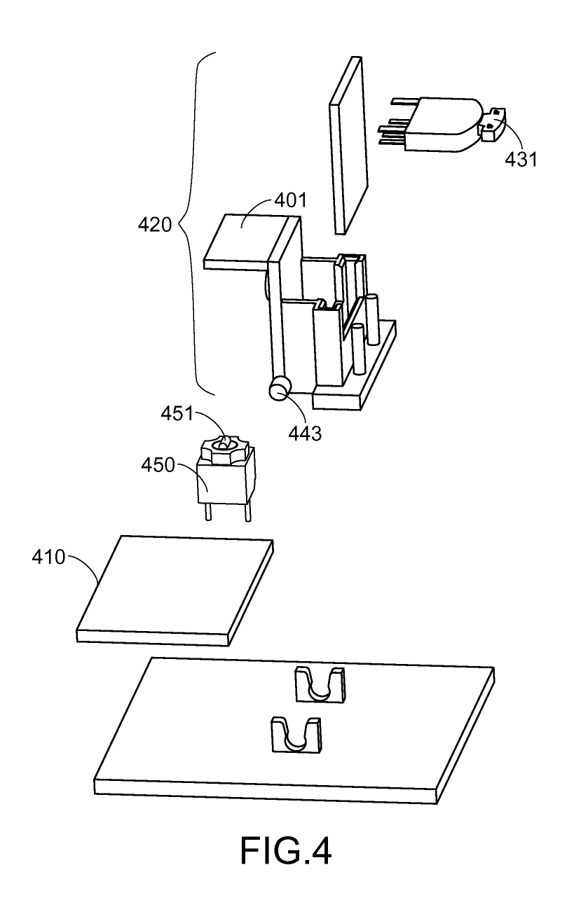

A further embodiment of a four-direction switch device is illustrated in FIG. 4. In this embodiment, the mother substrate, the base part, the three-direction switch element included therein are similar to those shown in FIG. 3, and are not to be redundantly described herein. In addition to the daughter substrate, the recess structure and the swing shaft 443, the swing module 420 further includes a pressing plate 401. Moreover, the push button 351 is arranged on the unidirectional switch element 450 and under the pressing plate 401 of the swing module 420. When the joystick part 431 is operated in the fourth direction, the swing module 420 is swung toward the unidirectional switch element 450 with the swing shaft 443 serving as a rotating shaft. Once the pressing plate 401 of the swing module 420 touches the push button 451 of the unidirectional switch element 450, the fourth direction switching signal is generated and transmitted to the mother substrate 410. Due to the restoring force of the push button 451, the swing module 420 will be then returned to its original position.

Moreover, the swinging range of the four-direction switch device in the fourth direction is controllable by adjusting the distance between the push button 451 of the unidirectional switch element 450 and the pressing plate 401 of the swing module 420. For example, if the distance between the push button 451 of the unidirectional switch element 450 and the pressing plate 401 of the swing module 420 is small, the joystick part 431 is tilted upwardly in a tiny shift amount. Whereas, if the distance between the push button 451 of the unidirectional switch element 450 and the pressing plate 401 of the swing module 420 is larger, the joystick part 431 is tilted upwardly in a larger shift amount. As a consequence, the touch feel of the four-direction switch device of the present invention is adjustable.

The present invention is illustrated by referring to a four-direction switch device for use with a mouse device. Nevertheless, the four-direction switch device of the present invention can be applied to other mobile electronic apparatuses such as mobile phones, personal digital assists (PDAs), MP3 players an the like.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1-2. (canceled)

3. The four-direction switch device according to claim 1 wherein said swing module further includes:
a first substrate for mounting said three-direction switch element thereon;
a recess structure for receiving said first substrate therein; and
a pressing plate for touching said unidirectional switch element.

4-5. (canceled)

6. The mouse device according to claim 5 wherein said swing module further includes:
a first substrate for mounting said three-direction switch element thereon;
a recess structure for receiving said first substrate therein; and
a pressing plate for touching said unidirectional switch element.

7. (canceled)

8. A four-direction switch device comprising:
a three-direction switch element comprising a joystick part for being operated in a forward direction , a backward direction and an inward direction for generating a first direction switching signal, a second direction switching signal and a third direction switching signal respectively;
a swing module comprising:
a first substrate for mounting said three-direction switch element thereon; and a single swing shaft; such that said swing module is swung with respect to said single swing shaft; and
a unidirectional switch element separated from the swing module and disposed beside the swing module, wherein said swing module is swung toward the unidirectional switch element and touches said unidirectional switch element, so that said unidirectional switch element generates a fourth direction switching signal.

9. The four-direction switch device according to claim 8, the swing module further comprising a recess structure for receiving said first substrate and the three-direction switch element therein.

10. A mouse device comprising:
a housing including a base part and a sidewall; and
a four-direction switch device comprising:
a three-direction switch element comprising a joystick part protruded from said sidewall part of said housing for being operated in a forward direction, a backward direction and an inward direction for generating a first direction switching signal, a second direction switching signal and a third direction switching signal respectively;
a swing module comprising:
a first substrate for mounting said three-direction switch element thereon; and
a single swing shaft; such that said swing module is swung with respect to said swing shaft when said joystick part is operated by a user; and
a unidirectional switch element separated from the swing module and disposed beside the swing module, wherein said swing module is swung toward
the unidirectional switch element and touches said unidirectional switch element, so that said unidirectional switch element generates a fourth direction switching signal.

11. The mouse device according to claim 10, the swing module further comprising a recess structure for receiving said first substrate and the three-direction switch element therein.

12. The mouse device according to claim 10 further including two supporting elements on said base part of said housing such that both ends of said swing shaft of said swing module are supported by said supporting elements.
